(19) United States
(12) Patent Application Publication
(10) Pub. No.: US 2006/0105096 A1
(43) Pub. Date: May 18, 2006

(54) Food composition

(76) Inventor: Kinya Takagaki, Fukuoka (JP)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/991,676

(22) Filed: Nov. 18, 2004

(51) Int. Cl. A23L 1/212

(52) U.S. Cl. 426/615

(57) ABSTRACT

The present invention provides a health food product comprising proanthocyanidins (A) and a food material (B) derived from a plant of Family Liliaceae. Preferably, the proanthocyanidins contain at least 20 wt % of OPCs.

### BACKGROUND OF THE INVENTION

1. Field of the Invention

The present invention relates to a health food product comprising proanthocyanidins and a food material derived from a plant of the Family Liliaceae.

2. Description of the Related Art

Stiff shoulders and lower back pain can be regarded as occupational diseases that are caused by poor blood circulation. Stiff shoulders and lower back pain are treated mainly with external preparations, which are applied to the skin in the affected part in the form of a patch, or by coating or rubbing. However, daily application of these external preparations to the same part of the skin may cause inflammation of the skin, and thus, in some cases, these external preparations cannot be used for a long period of time.

Moreover, in recent years, occupations using a computer have been increasing. Accordingly, the number of people who experience eyestrain due to working for long hours while staring at a monitor and staying in a certain posture and as a result, suffer from stiff shoulders and lower back pain also have been increasing. Such stiff shoulders and lower back pain can cause great pain in daily work.

Therefore, there is a demand for providing a preparation for improving stiff shoulders and lower back pain, the effect of which continues for a long period of time, wherein the preparation is not an external preparation.

### SUMMARY OF THE INVENTION

The present invention provides a health food product comprising a proanthocyanidin (A) and a food material (B) derived from a plant of the Family Liliaceae. This health food product can be ingested easily and is able to alleviate stiff shoulders and lower back pain.

In one embodiment, the proanthocyanidin is derived from a bark of pine; a fruit or seeds of grape, blueberry, strawberry, avocado, locust, or cowberry; barley; wheat; soybean; black soybean; cacao; an inner skin of peanuts; or leaves of ginkgo.

In one embodiment, the plant of the Family Liliaceae is at least one selected from the group consisting of Allium cepa, Allium sativum, Allium fistulosum, Allium odorum, and Allium bakeri.

In a preferred embodiment, the proanthocyanidin comprises at least 20 wt % of OPC (oligomeric proanthocyanidin).

According to the present invention, it was found that when ingesting a health food product that contains proanthocyanidins (A) and a food material (B) derived from a plant of the Family Liliaceae, stiff shoulders and lower back pain can be alleviated. In particular, when using proanthocyanidins that contain at least 20 wt % of OPCs, stiff shoulders and lower back pain can be alleviated effectively.

### DESCRIPTION OF THE PREFERRED EMBODIMENT

Hereinafter, the health food product of the present invention will be described. It should be noted that the following description is not limiting the present invention, and it is apparent to those skilled in the art that various alternations can be made within the scope of the spirit of the present invention.

The health food product of the present invention contains proanthocyanidins (A) and a food material (B) derived from a plant of the Family Liliaceae. Hereinafter, the components will be described.

(A) Proanthocyanidins

In the present invention, proanthocyanidins refer to a group of compounds that are condensation products having flavan-3-ol and/or flavan-3,4-diol as a constituent unit and having a degree of polymerization of 2 or more. Proanthocyanidins are known to have various activities such as an antioxidation ability.

In this specification, among proanthocyanidins, condensation products having flavan-3-ol and/or flavan-3,4-diol as a constituent unit and having a degree of polymerization of 2 to 4 are referred to as oligomeric proanthocyanidins (OPCs). OPCs, which are one type of polyphenol, are potent antioxidants produced by plants, and contained concentratedly in portions of plant leaves, bark, or skin or seeds of fruits. More specifically, they are contained in the seeds of grape; the bark of pine; the inner skin of peanuts; ginkgo; the fruit of locust; and cowberry, for example. Moreover, it is known that OPCs are also contained in cola nuts in West Africa; the roots of Rathania in Peru; and Japanese green tea. OPCs cannot be produced in the human body.

For the proanthocyanidins contained in the health food product of the present invention, foodstuff raw materials such as ground products or extracts obtained from the fruit or seeds of grape, blueberry, strawberry, avocado, and the like can be used. In particular, it is preferable to use a pine bark extract. Among proanthocyanidins, OPCs are especially abundant in pine bark, and thus, a pine bark extract is preferably used as a raw material of the proanthocyanidins in the present invention.

Hereinafter, a method for preparing proanthocyanidins will be described taking a pine bark extract that contains OPCs abundantly as an example.

As the pine bark extract, an extract from the bark of a plant belonging to Pinales, such as French maritime pine (Pinus martima), Larix leptolepis, Pinus thunbergii, Pinus densiflora, Pinus parviflora, Pinus pentaphylla, Pinus koraiensis, Pinus pumila, Pinus luchuensis, utsukushimatsu (Pinus densiflora form. umbraculifera), Pinus palustris, Pinus bungeana, and Anneda in Quebec, Canada, can be preferably used. Among these, French maritime pine (Pinus martima) bark extract is preferable.

French maritime pine refers to maritime pines that grow in a part of the Atlantic coastal area in southern France. It is known that the bark of this French maritime pine contains proanthocyanidins, organic acids, and other bioactive substances, and proanthocyanidins from the flavonoid family, which are the main component of the French maritime pine bark, have a potent antioxidation ability of removing active oxygen.

The pine bark extract is obtained by extracting the bark of the above-described pines using water or an organic solvent. When water is used, warm water or hot water can be employed. As the organic solvent that can be employed for extraction, an organic solvent that is acceptable for production of foods or pharmaceuticals can be employed. Examples of such solvent include methanol, ethanol, 1-propanol, 2-propanol, 1-butanol, 2-butanol, butane, acetone, hexane, cyclohexane, propylene glycol, aqueous ethanol, aqueous propylene glycol, methyl ethyl ketone, glycerin, methyl acetate, ethyl acetate, diethyl ether, dichloromethane, edible oils or fats, 1,1,1,2-tetrafluoroethane, and 1,1,2-trichloroethene. The water and the organic solvents may be used alone or in combination. In particular, hot water, aqueous ethanol, and aqueous propylene glycol are preferably used.

The method for extracting proanthocyanidins from pine bark is not particularly limited, and heat extraction or supercritical fluid extraction can be employed, for example.

Supercritical fluid extraction is a method for performing extraction using a supercritical fluid. A supercritical fluid is in a state that is above the liquid-vapor critical point in the phase diagram showing critical temperature and critical pressure. Examples of compounds that can be employed as a supercritical fluid include carbon dioxide, ethylene, propane, and nitrous oxide (laughter gas). Carbon dioxide is preferably used.

Supercritical fluid extraction includes an extraction step in which a target component is extracted with a supercritical fluid and a separation step in which the target component is separated from the supercritical fluid. In the separation step, any separation process can be employed, examples of which include a separation based on a change in pressure, a separation based on a change in temperature, and a separation using an adsorbent or absorbent.

Moreover, it is also possible to perform supercritical fluid extraction in which an entrainer is added. In this method, extraction is performed using an extracting fluid obtained by adding, for example, ethanol, propanol, n-hexane, acetone, toluene, or another aliphatic lower alcohol, aliphatic hydrocarbon, aromatic hydrocarbon, or ketone at about 2 to 20 W/V % to a supercritical fluid, so that the solubility of a target substance to be extracted, such as OPCs and catechins (described later), in the extracting fluid is dramatically increased or the selectivity of separation is enhanced. Thus, a pine bark extract is obtained efficiently.

Since supercritical fluid extraction can be performed at a relatively low temperature, it has the following advantages: it is applicable for extracting substances that deteriorate or decompose at high temperatures; the extracting fluid does not remain; and the extracting fluid can be recovered and recycled, so that a step of removing the extracting fluid and the like can be omitted, and thus, the process can be simplified.

Furthermore, methods other than those mentioned above can be employed for extraction from pine bark, and examples thereof include a batch method using liquid carbon dioxide, a reflux method using liquid carbon dioxide, a reflux method using supercritical carbon dioxide, and the like.

It is also possible to employ a combination of a plurality of extraction processes to perform extraction from pine bark. By combining a plurality of extraction processes, pine bark extracts with various components can be obtained.

The pine bark extract that is used for the health food product of the present invention is specifically prepared using the following method. However, this method is merely an example, and the pine bark extract used for the present invention is not limited the extract obtained by this method.

First, 1 kg of the bark of French maritime pine is immersed in 3 L of a saturated solution of sodium chloride, and extraction is performed for 30 minutes at 100° C. to obtain an extract liquid (extraction step). Then, the extract liquid is filtrated, and the resultant insoluble material is washed with 500 ml of a saturated solution of sodium chloride to obtain a washed liquid (washing step). The extract liquid and the washed liquid are combined to obtain a crude extract liquid of pine bark.

Next, 250 ml of ethyl acetate is added to this crude extract liquid, mixed, and separated to obtain an ethyl acetate layer. This process is repeated five times, and the obtained ethyl acetate layers are combined. The resultant ethyl acetate extract is added directly to 200 g of anhydrous sodium sulfate for drying. Then, this ethyl acetate extract is filtrated, and the filtrated extract is concentrated under a reduced pressure to a volume of ⅕ of the original filtrated extract. The concentrated ethyl acetate extract is poured into 2 L of chloroform and stirred, and the resultant precipitate is recovered by filtration. Subsequently, this precipitate is dissolved in 100 ml of ethyl acetate, and then the resultant solution is added to 1 L of chloroform to form a precipitate. This process is repeated twice, and thus, a washing process is accomplished. With this method, for example, about 5 g of pine bark extract containing at least 20 wt % of OPCs that have a degree of polymerization of 2 to 4 and at least 5 wt % of catechins can be obtained.

Extracts from the above-described raw material plants, in particular, pine bark extracts, which are typically used for the proanthocyanidins (A) in the health food product of the present invention, contain proanthocyanidins that are condensation products having flavan-3-ol and/or flavan-3,4-diol as a constituent unit and having a degree of polymerization of 2 or more. Among these, extracts that contain a large amount of condensation products having a lower degree of polymerization are preferably used. As such condensation products, condensation products having a degree of polymerization of 2 to 30 (dimer to 30-mer) are preferable, condensation products having a degree of polymerization of 2 to 10 (dimer to decamer) are more preferable, and condensation products having a degree of polymerization of 2 to 4 (dimer to tetramer; i.e., OPCs) are even more preferable.

Since OPCs are antioxidants as described above, they also provide an effect of reducing the possibility of adult diseases, such as cancer, cardiac diseases, and cerebral thrombosis, an effect of improving allergic diathesis, such as arthritis, atopic dermatitis, and pollenosis, and the like.

Furthermore, it is known that in addition to the antioxidation effect, OPCs also provide, for example, an effect of inhibiting bacterial proliferation in the oral cavity to reduce plaque (dental plaque); an effect of recovering the elasticity of blood vessels; an effect of preventing lipoprotein in blood from being damaged by active oxygen, thereby preventing aggregation and adherence of the oxidized fats onto the inside wall of the vessel, thus preventing cholesterol from being aggregated and adhered onto the oxidized fats that have been adhered onto the inside wall of the vessel; an effect of regenerating vitamin E that has been degraded by active oxygen; and an effect of serving as an enhancer of vitamin E.

In the present invention, proanthocyanidins containing at least 20 wt % of OPCs are preferably used. More preferably, the OPC content is at least 30 wt %. For such proanthocyanidins, a pine bark extract is preferably used.

When proanthocyanidins having a high OPC content are used, a better effect of improving stiff shoulders and lower back pain can be achieved than in the case where proanthocyanidins having a high degree of polymerization (having a low OPC content) are used.

Moreover, proanthocyanidin contents derived from raw material plants, in particular, plant extracts contain catechins as well as OPCs. The term “catechins” is a general term referring to polyhydroxyflavan-3-ols. As the catechins, for example, (+)-catechin, (−)-epicatechin, (+)-gallocatechin, (−)-epigallocatechin, epigallocatechin gallate, and epicatechin gallate are known. Gallocatechin, afzelechin, and 3-galloyl derivatives of (+)-catechin or gallocatechin are isolated from natural products, in addition to (+)-catechin that is called catechin in a narrow sense. Catechins are known to have a cancer inhibiting ability, an arteriosclerosis preventing ability, a lipid metabolism disorder inhibiting ability, a blood pressure elevation inhibiting ability, a thrombosis preventing ability, an antiallergic ability, an antiviral ability, an antibacterial ability, a dental caries preventing ability, a halitosis preventing ability, an intestinal flora normalization ability, an active oxygen or free radical eliminating ability, an antioxidation ability, and the like. Moreover, catechins are known to have an antidiabetic ability that inhibits an elevation of blood glucose. Furthermore, catechins have the property of both increasing the solubility in water and being activated in the presence of OPCs.

It is preferable that catechins are contained in the above-described raw material plant extract in a ratio of 5 wt % or more. More preferably, a formulation is prepared so that it contains raw material plant extract containing at least 20 wt % of OPCs and furthermore, contains catechins in a ratio of 5 wt % or more. For example, when the catechin content in a pine bark extract is less than 5 wt %, it is possible to add catechins so that the catechin content becomes at least 5 wt %. It is most preferable to use a pine bark extract containing at least 5 wt % of catechins and at least 20 wt % of OPCs.

(B) Food Materials Derived from Plant of the Family Liliaceae

The health food product of the present invention contains a food material (B) derived from a plant of the Family Liliaceae (hereinafter, referred to as a Liliaceae plant). Liliaceae plants contain sulfur-containing organic compounds abundantly, and the amount of which is greater than that of other plants. Sulfur-containing organic compounds are known to have various abilities such as an ability of decreasing blood glucose, an ability of decreasing lipid levels, a sedative ability, a platelet aggregation inhibiting ability, and a cancer inhibiting ability.

The Liliaceae plants that are raw materials of the food material used for the present invention are materials commonly used for foods, and typical examples thereof include plants belonging to Genus Aloe or Genus Allium. Examples of plants that contain sulfur-containing compounds very abundantly include Liliaceae plants belonging to Genus Allium, such as Allium odorum (leek), Allium fistulosum (Welsh onion), Allium sativum (garlic), Allium bakeri (scallion), and Allium cepa (onion).

Examples of the food material derived from a Liliaceae plant that can be used for the health food product of the present invention include edible portions of crude Liliaceae plants and any food materials obtained by processing these edible portions using a technique that is commonly employed by those skilled in the art. Examples of such processed food materials include dry powder of Welsh onion, dried Welsh onion, onion extract obtained by squeezing onion, and dry powder (powdered extract) obtained by drying the onion extract. In the present invention, it is preferable to use a food material obtained by processing a Liliaceae plant that contains a sulfur-containing compound very abundantly as described above.

The health food product of the present invention contains proanthocyanidins (A) preferably in a ratio of 0.5 to 150 parts by weight and more preferably in a ratio of 1 to 100 parts by weight with respect to 100 parts by weight of a food material (B) derived from a Liliaceae plant. The weight of the Liliaceae plant is calculated in terms of its dry weight, and when a dry powder of the Liliaceae plant is employed, the weight is determined by the use of the dry powder in which fibers are not removed.

The health food product of the present invention contains the above-described proanthocyanidins (A) and food material derived from a Liliaceae plant (B), and contains a variety of types of additives that are commonly used for foods, if necessary. Examples of such additives include excipients, extenders, binders, thickeners, emulsifiers, coloring agents, flavors, and food additives. For example, the health food product of the present invention may be produced in the form of, for example, tablets or pills by adding an excipient and the like to a pine bark extract that contains proanthocyanidins abundantly and garlic extract powder, or it may be produced in the form of powder or in other forms without being shaped.

It is also possible to be made into the forms of capsules such as hard capsules and soft capsules, powder, granule, tea bags, candy, liquid, and paste.

Furthermore, nutritions such as royal jelly, vitamins, proteins, calcium substances such as eggshell calcium, chitosan, lecithin, chlorella powder, Angelica keiskei powder, and molokheiya powder, also can be added. It is also possible to add stevia powder, ground green tea powder, lemon powder, honey, maltitol, lactose, sugar solutions, seasoning agents, and the like so as to control taste.

Regarding the method for ingesting the health food product of the present invention, there is no particular limitation. According to the form of the health food product of the present invention or according to the preference, the health food product may be eaten or drunk as it is, or may be dissolved in water, hot water, milk, or the like and drunk. Alternatively, a liquid in which the components of the health food product obtained by percolation may be drunk.

Although there is no limitation regarding the daily intake amount of the health food product of the present invention, it is preferable that the amount of proanthocyanidins (A) is 20 mg to 2000 mg, and the amount of the food material (B) derived from a Liliaceae plant is at least 5 g in terms of wet weight of the edible portion. In other words, when a dry powder that is obtained from an edible portion of a Liliaceae plant having a moisture content of 80% is used as the food material (B) derived from a Liliaceae plant, the amount is preferably at least 1 g. In the case of a powdered extract that has a twentieth weight of the original edible portion, the amount is preferably at least 0.25 g, wherein the powdered extract is obtained by a process of removing dietary fibers from the edible portion to obtain an extract and then drying the extract.

It seems that the health food product of the present invention can alleviate stiff shoulders and lower back pain because various bioactivities of the components (A) and (B) cooperate to improve the health condition of the body.

### EXAMPLE

Hereinafter, the present invention will be described by way of an example. However, the present invention is not limited to this example.

### Example 1

Tablets (about 220 mg per tablet) were produced using an ethanol extract of pine bark (trade name: Flavangenol, produced by TOYO SHINYAKU Co., Ltd.) containing 40 wt % of proanthocyanidins (OPC content: 20 wt % in the extract) and 5 wt % of catechins, an onion extract powder (trade name: Onion extract powder, produced by TOKAI BUSSAN CO., LTD.), crystalline cellulose, sucrose ester, silicon dioxide, and eggshell calcium according to the weight ratio shown in Table 1 below. These tablets were referred to as “Food 1”.

Ten volunteers (men between the ages of 22 and 52) who were suffering from stiff shoulders and lower back pain ingested 12 tablets of this Food 1 daily for four weeks. After the ingestion, the volunteers performed self-assessment of the degree of stiff shoulders and lower back pain using the criteria listed below. It should be noted that volunteers were divided into groups randomly except that the number of volunteers of similar age was equal among the groups:

| | | |
|---|---|---|
| Significantly improved: | 2 | points |
| Improved: | 1 | point |
| Unchanged: | 0 | points |

Table 2 shows the results. The results in Table 2 indicate the averages of the marks given by the ten subjects.

### Comparative Examples 1 and 2

Tablets (Foods 2 and 3) containing only one of the components (A) and (B) were produced according to the weight ratio shown in Table 1 below, and the degree of stiff shoulders and lower back pain was assessed in the same manner as in Example 1. Table 2 also shows the results.

TABLE 1

| | | Ex. 1 | Com. Ex. 1 | Com. Ex. 2 |
|---|---|---|---|---|
| Components | | Food 1 | Food 2 | Food 3 |
| (A) | Pine bark extract | 20 | 20 | — |
| (B) | Onion extract powder | 15 | — | 15 |
| Additives | Crystalline cellulose | 10 | 10 | 10 |
| | Sucrose ester | 5 | 5 | 5 |
| | Silicon dioxide | 2 | 2 | 2 |
| | Eggshell calcium | 48 | 63 | 68 |

The unit of the values is parts by weight.

TABLE 2

| | Ex. 1 | Com. Ex. 1 | Com. Ex. 2 |
|---|---|---|---|
| Response items | Food 1 | Food 2 | Food 3 |
| Stiff shoulders | 1.5 | 0.7 | 0.2 |
| Lower back pain | 1.4 | 0.6 | 0.3 |

Referring to the results shown in Table 2, it can be seen that when compared with the cases of the foods containing only either of the components (A) or (B), stiff shoulders and lower back pain were alleviated more in the case of the food of the example that contains both of these components.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A health food product comprising a proanthocyanidin (A) and a food material (B) derived from a plant of the Family Liliaceae.

2. The health food product of claim 1, wherein the proanthocyanidin is derived from a bark of pine; a fruit or seeds of grape, blueberry, strawberry, avocado, locust, or cowberry; barley; wheat; soybean; black soybean; cacao; an inner skin of peanuts; or leaves of ginkgo.

3. The health food product of claim 1, wherein the plant of the Family Liliaceae is at least one selected from the group consisting of Allium cepa, Allium sativum, Allium fistulosum, Allium odorum, and Allium bakeri.

4. The health food product of claim 1, wherein the proanthocyanidin comprises at least 20 wt % of OPC (oligomeric proanthocyanidin).
